(19) United States
(12) Patent Application Publication
(10) Pub. No.: US 2025/0278670 A1
(43) Pub. Date: Sep. 4, 2025

(54) ACCELERATING GROUND TRUTH ANNOTATION USING ARTIFICIAL INTELLIGENCE

(71) Applicant: Nvidia Corporation, Santa Clara, CA (US)

(72) Inventors: James Michael Skinner, Arvada, CO (US); Tian Xia, Scarsdale, NY (US); Yi Lu, Shanghai (CN); Tilman Wekel, San Jose, CA (US)

(21) Appl. No.: 18/604,129

(22) Filed: Mar. 13, 2024

(30) Foreign Application Priority Data
Feb. 29, 2024 (WO) PCT/CN2024/079426

(51) Int. Cl. G06N 20/00; G06N 7/01

(52) U.S. Cl. CPC G06N 20/00; G06N 7/01

(57) ABSTRACT

Approaches presented herein provide for the acceleration of a human review process, such as the review of annotations generated by a human labeler. Annotations (at least partially) generated by a human reviewer can be provided as input to a machine learning model trained to infer a probability of the annotations including at least one error. Annotations with a low probability of including an error can be approved automatically, while annotations with a high probability (e.g., above a threshold) of including an error can be directed for human review. In order to keep the human reviewer engaged, artificial errors may be introduced at various times based on various engagement criteria.

### CROSS-REFERENCE TO RELATED APPLICATIONS

This application claims priority to PCT Application Serial No. PCT/CN2024/079426 filed Feb. 29, 2024, and entitled “ACCELERATING GROUND TRUTH ANNOTATION USING ARTIFICIAL INTELLIGENCE,” which is hereby incorporated herein in its entirety and for all purposes.

### BACKGROUND

When performing an operation—such as training a machine learning model—it is generally necessary to have a sufficient amount of ground truth training data to produce reliable inferences. In many instances, ground truth data will involve a human annotator applying some type of annotation, such as a category label, to each applicable instance of data. Because human annotators can make mistakes, it can be necessary, particularly when the quality of the annotations is vital, to employ a second human reviewer to verify the annotations applied by the first human annotator. For sensor data captured of various environments to be used for operations such as autonomous or semi-autonomous vehicle navigation, this can include employing specialized “quality assurance” personnel to review the labels and spot errors before those errors influence the corresponding algorithms and safety key performance indicators (KPIs). Unfortunately, such quality assurance personnel are expensive, and the repetitive nature of this large volume task can lead to poor performance. Further, there is latency introduced in the time it takes an annotator to receive and annotate an instance of data, additional time for the reviewer to receive and review, and potentially multiple iterations until the data instance is approved, which can result in unacceptable or undesirable delays in obtaining sufficiently updated and accurate training data.

### BRIEF DESCRIPTION OF THE DRAWINGS

Various embodiments in accordance with the present disclosure will be described with reference to the drawings, in which:

FIGS. 1A and 1B illustrate annotations that can be generated for objects represented in an instance of input data, according to at least one embodiment;

FIG. 2 illustrates components of an example system that can be used to generate and approve annotations, according to at least one embodiment;

FIGS. 3A and 3B illustrate example processes for generating, modifying, and/or approving annotations, according to at least one embodiment;

FIG. 4A illustrates a set of annotations intentionally modified to include an error, according to at least one embodiment;

FIG. 4B illustrates a distribution of annotation quality scores, according to at least one embodiment;

FIG. 5 illustrates an example process for determining to perform an engagement action with respect to a human reviewer, according to at least one embodiment;

FIG. 6 illustrates components of a distributed system that can be used to generate, modify, and/or approve annotations, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI with large language models (LLMs), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

Approaches in accordance with various illustrative embodiments provide for a reduction in the amount of quality assurance (QA) to be performed when human labelers generate annotations for input data, such as spatial object data that is to serve as ground truth to train—e.g., update one or more parameters (e.g., weights and biases) of—a machine learning model. A human labeler can be presented with an instance of data, such as a set of LiDAR data captured for a region of an environment, and can be tasked with providing annotations for specific types of objects identified in the instance. The annotations in at least one embodiment can include a boundary (e.g., a geometric representation with nine degrees of freedom), a label (e.g., a type of object such as an automobile or pedestrian), and one or more attributes for each such object (e.g., indicating the automobile is a police car, or that a road sign is a speed limit sign, etc.), among other such options.

Instead of having every set of annotations reviewed by a second human, or QA reviewer, individual sets of annotations from a human labeler can be processed using a machine learning model (e.g., a linear regression model) to attempt to determine a risk score, or other such measure of risk or error. A risk score can be compared against a risk threshold, or other such criterion, to classify the set of annotations as having a high-risk of containing at least one error, or having a low-risk of containing an error. The machine learning model can be trained to determine risk based upon various factors, such as the type of labeling task, the proportion of objects with an annotation, the locations of objects in different distance bins, and the historical performance of the individual human labeler, among other such options. Sets of annotations that are classified as high-risk can be passed to a QA reviewer for review. In at least one embodiment, a small sampling of low-risk jobs can also be passed for review as well. The risk threshold can be adjustable based upon factors such as a risk tolerance of a provider of the labeling task. Such an approach can help to significantly reduce the time and expense for performing QA, while capturing the majority of errors in the human-generated annotations. Because QA reviewers can have issues with remaining engaged over time, particularly when there are long periods of review with no errors spotted, approaches can also introduce errors into the sets of annotations, such as to add, shift, or remove an annotation, which can help to keep the QA reviewer engaged. A determination can also be made as to whether the QA reviewer caught the error, and if not, then another step can be taken to improve engagement.

Variations of this and other such functionality can be used as well within the scope of the various embodiments as would be apparent to one of ordinary skill in the art in light of the teachings and suggestions contained herein.

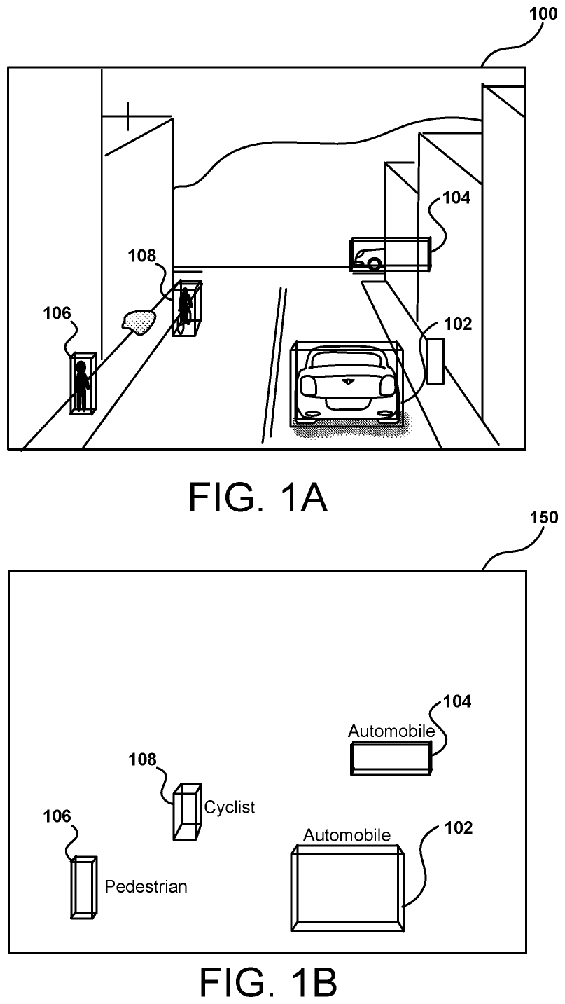

As mentioned, in many instances, the generation of ground truth data can be an expensive and time-consuming task that involves significant manual effort. As an example, the generation of ground truth data can involve the capture of hundreds of millions of frames or instances of sensor data while a sensor-equipped vehicle(s) drives around the streets of a particular geographic region. FIG. 1A illustrates an example image 100 that can be captured by a camera of such a vehicle in such a location, although in many instances other types of data such as LiDAR data, RADAR data, ultrasonic data, etc. might be captured for analysis. In many instances, such an image 100 would be stored to a queue to wait for analysis and annotation by a human annotator. While some amount of pre-processing may be performed, such as to have some annotation suggestions performed by a computer vision- or machine learning-based system, a human annotator will still have to look at the image (or other instance of data—such as a point cloud) in many instances and apply, remove, or modify annotations as the human deems appropriate. A human annotator can be tasked with identifying the locations of certain types of objects in a captured image 100, such as to draw a boundary (e.g., a bounding shape, box, or cuboid) around such an object when identified in the image. As illustrated, this can include a larger cuboid 102 that can be created for a vehicle represented to be closer to the camera, and thus appears larger in the captured image 100, than a cuboid 104 for a vehicle that is represented to be further away in the captured image 100. Each cuboid can be created by similar or alternative approaches, such as through drawing, pasting, dragging, and/or resizing of a cuboid (or other geometric representation) by an annotator using an interface, such as a graphical user interface (GUI) of an annotation application. As mentioned, in some instances a proposed initial cuboid might be generated by an automated process that can then be modified by an annotator, among other such options. When creating or adjusting such a cuboid, the annotator can attempt to match the size of the cuboid to the size of the object that is being annotated. This cuboid will be an approximation, however, as there will be some imprecision in the human-based adjustment—in potentially each of nine degrees of freedom—as well as some imprecision due to the limited accuracy of the measurement and/or resolution of the image being displayed, along with sensor imprecision and other such sources. There will be some imprecision due in part to the two-dimensional (2D) nature of the image. For example, a first cuboid 102 can be created for a vehicle that is visible from the back in the image, such that the front of the vehicle is not visible. The annotator must then estimate where the front of the vehicle is in order to create a relatively accurate cuboid. For operations such as navigation, the front of the car may not be as important if following that car from behind, as the risk of collision is based primarily on the location of the rear of the vehicle. However, for path determination purposes and/or prediction of movement of operations of objects around that car, it can be important that the shape of the cuboid is relatively accurate. Further, there may be some objects that are at least partially obstructed by one or more other objects in the 2D image, and the annotator must estimate an appropriate size and shape of the cuboid, such as for the cuboid 104 in the image 100 that is partially obstructed by a building. In some embodiments an annotator must rely on their experience with annotating different types of objects to create appropriate geometric representations, while in some embodiments there may be software tools to help guide the creation or annotation process based at least in part upon object sizing rules or object size learning, etc. The position and size of the cuboid should be sufficiently precise that the cuboid accurately represents the location (and size, etc.) of the object in the relevant coordinate system to make decisions based in part upon that location so as to be able to satisfy at least one operation criterion, such as to not collide with that object if using that location to navigate a vehicle.

As illustrated in the example image 100, an annotator can generate appropriately-sized geometric annotations for various types of objects, such as a cuboid 106 for a pedestrian and a cuboid 108 for a cyclist, in addition to cuboids 102, 104 for vehicles. As illustrated, for many embodiments an annotator only needs to annotate certain types of objects, and not every object visible in an image. The types of objects to be annotated can vary by operation, task, or other such factor. In an example where there may be sufficiently reliable static map data, such as high-definition (HD) map data, the annotation process can focus on dynamic or moveable objects that may be likely to pass in or near a path of operation of a vehicle, and thus should be accounted for in a navigation, collision avoidance, or other such operation. Thus, in this example, the annotator does not need to annotate buildings, mailboxes, sidewalks, bushes, and the like.

FIG. 1B illustrates a view 150 of only the annotations that were applied to the image 100 of FIG. 1A. As illustrated, this view includes the cuboids generated for each identified object of interest. In addition to the geometric representation, the annotator will add at least some label, contextual, or semantic information that is applicable to a given annotated object, where the type of information can also vary by task or operation, and can be configurable by an authorized user. A basic annotation might indicate, in human-readable text, a type or category of object, such as “automobile” or “pedestrian.” Other information may be added as well if applicable, such as “moving,” “stationary,” “bus,” or “delivery van,” for example, which might help predict the future motion of those objects based on patterns of learned behavior. In some embodiments, the labels or information to be applied might be presented to the user in human-readable text but stored to the annotation using some type of encoding, identifier, or representation that may require less storage. In some examples the annotation labels may have some flexibility in language used, while in other examples there may be only a fixed set of labels able to be applied.

Once an annotator believes they have accurately annotated an image, the annotator can submit the set of annotations for review. The annotations of view 150, along with the corresponding image 100 or instance of input data, can be written to a queue, along with other annotations generated for other images (or sets of sensor data) generated by this annotator as well as other annotators, who may also have different skillsets, levels of knowledge, or experience, and may come from different regions with different languages, types of objects, or other potentially relevant variations. One or more reviewers can then pull annotations from this queue to review. The reviewer can check the size and shape of each geometric representation, as well as accuracy of the label or descriptive text (or other such information) associated with each annotation. The reviewer can also check to make sure that the annotations accurately capture all objects of the types that should be annotated in the associated image, at least that meet one or more annotation criteria (such as being represented with sufficient detail in the image to make a reasonable inference or determination as to size and type of objects). The reviewer can also check to ensure that the annotations do not identify any object that is not of a type or quality that should have an annotation applied, such as where a vehicle represented on a billboard on the side of the highway was accidentally annotated, or where a tractor trailer was accidentally mislabeled as two separate vehicles, etc. In many instances the human reviewer will rely upon the reviewer's training and experience to make these decisions, but in some embodiments there may also be at least some amount of suggestion or analysis performed by one or more software tools, such as automated annotation tools discussed previously. If the reviewer is satisfied that the annotations are sufficiently accurate, then the reviewer can approve the set of annotations for the image and the set of annotations with the image can be provided and/or stored for their intended use, such as to be used as ground truth data to train a machine learning model.

If, however, the human reviewer determines that there is at least one inaccuracy that needs correction, then the reviewer can return the image and annotations for correction by a reviewer, which could be the same reviewer or a different reviewer. In some embodiments the reviewer might make the recommended changes, might provide information about recommended changes, or may rely on the annotator to determine the necessary corrections. In at least some instances, two people need to agree on the annotations before they can be approved, while in other instances annotations might only be able to be edited or modified by an annotator and then approved by a reviewer, etc. Thus, even if a reviewer makes recommended corrections, the recommended corrections often need to go back to the annotator to process. The annotator may then make, modify, or accept the recommended changes, which can then go back to a reviewer for approval. This process can continue, using the same or different annotators and reviewers, until a set of annotations is approved. This may require many iterations, observed to take potentially dozens of iterations for complex images. For each iteration, it will take some time to perform the corrections or review, and there will likely be some amount of time for each iteration for the data to wait in one or more queues until someone is available to process. As mentioned, this can result in a lengthy and expensive process, and can also limit the amount of training data that can accurately be produced over a period of time. For operations such as autonomous navigation where a large volume of reliable training data is critical, such a result is less than ideal, and in some instances may lead to undesirable outcomes.

Further still, because such an approach relies upon a huge volume of training data to be processed by a finite number of annotators and reviewers, there can be errors in the data that result from the inherent behavior of people tasked to perform a large number of repeated operations. For example, a reviewer might review hundreds or even thousands of sets of annotations a day, and in many of those instances the annotations may be correct. It can be hard for a human reviewer to provide an equal amount of effort and focus on each set of annotations, particularly after a significant number of annotations have been reviewed, and where a sequence of annotations may have required no adjustments or significant manual effort on the part of the reviewer. Similarly, an annotator will also not apply the same amount of effort and concentration on each image to be annotated, such that the quality of the annotations can vary over the length of a shift, as well as over days of the week. Accordingly, it would be beneficial in at least some embodiments to be able to automatically identify those annotations that are most likely to be incorrect and ensure more effort is taken reviewing those annotations. It can also be beneficial to inject incorrect annotations and/or remove correct annotations at various times in order to be able to determine a current level of concentration of a human reviewer or annotator, or at least help to improve the level of concentration or focus by ensuring that there is at least some variety in the tasks of the human reviewer or annotator, to improve overall quality.

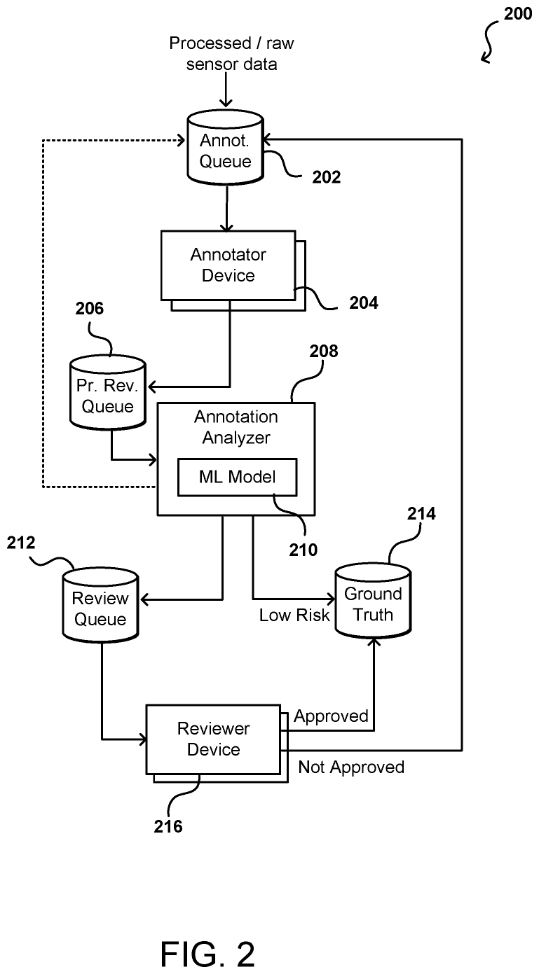

Approaches in accordance with various embodiments can attempt to overcome these and other such deficiencies in existing annotation approaches by using machine learning to perform at least some of the review process. Such an approach can help to reduce the amount of human review needed, while also ensuring that human review is focused on the annotations that are most likely to benefit from human review. FIG. 2 illustrates an example system 200 that can use a trained machine learning model 210 as part of an annotation analyzer system 208, module, or process. In such an approach, data to be annotated can be written to an annotation queue 202. This information may include, for example, raw or processed sensor data, such as image, LIDAR, point cloud, depth, and/or other such data, in two or three dimensions. For other types of operations, this may include other types of data, and can include any data or content that is to be reviewed by a human reviewer for some type of labeling, identification, verification, or other such action. When available and ready, an instance of data to be annotated can be pulled from the annotation queue 202 and provided to an annotator device 204 associated with a human annotator. This can include, for example, a desktop, laptop, or tablet computer with a user interface and application functionality enabling the human user to view (or otherwise receive a presentation of) the instance of data, and make any appropriate annotation. While the type of annotation device is not critical in at least some embodiments, the device should have sufficient resources or capabilities to allow the annotator to make accurate annotations, such as to have a display with sufficiently high resolution and size to enable an annotator to create sufficiently accurate geometric representations of objects in an image or point cloud. The annotator can create the appropriate annotations, including labels, geometric representations, and/or other such aspects, and can finalize the annotations for review, which can cause the annotations to be stored (associated with the image or annotated data) to a preliminary review queue 206.

Using prior approaches, the annotations in the preliminary review queue 206 could be held until they are able to be reviewed by a human reviewer using a reviewer device 216. As mentioned, however, there can be downsides to having a human reviewer have to review each of a large set of annotations produced, particularly when most of the sets will be sufficiently accurate. In this example, the annotations generated by human annotators and stored to a preliminary review queue 206 can be passed to a machine learning model 210 to determine a level of risk that the annotations contain at least one error. In should be understood that in some systems such a preliminary review queue 206 may not be needed if the machine learning model 210 is generally available to process these annotations without significant delay. The machine learning model 210 can analyze the annotations to determine a likelihood of error. If the annotations are determined to have a low-risk of error, then the annotations can be approved and do not need to be passed to a human reviewer. In this example, the low-risk annotations can be approved for storage to a ground truth repository for use in training one or more machine learning models (or performing other such operations).

If the annotations are determined to have a high-risk of error (e.g., exceeding some threshold value, or in some instances are determined to actually have an error) then the annotations can be written to a review queue 212 to be reviewed by a human reviewer. A set of annotations can be considered to be “high-risk” (or have a similar determination made) if the probability of error determined for the set is at or above a specified risk threshold, where that risk threshold can be adjustable based on various factors, such as type of operation to be performed, user preference, resource capacity or performance, and the like. In at least one embodiment, if a machine learning model 210 or annotation analyzer system 208 detects an actual error, such as a missing label, incomplete geometric representation, or label using incorrect terminology, then the annotation analyzer system 208 might return the annotations to an annotation queue 202 to have an annotator make a revision instead of providing the incorrect annotations for human review.

When a reviewer is available to review one of the sets of annotations in the review queue 212, the set of annotations can be pulled from the review queue 212 to the corresponding reviewer device 216 for review. As mentioned, the reviewer can review the accuracy of the annotations, including verifying that all appropriate objects have been annotated and there are no annotations of false or incorrect objects (e.g., objects of a type that is not to be annotated), all labels are correct, the geometric (or positional) representations is reasonably accurate, etc. If the reviewer believes that the set of annotations is correct, or at least within tolerance or acceptable ranges, then the set of annotations can be approved and written to the ground truth repository 214 for use in one or more operations. If, however, the reviewer believes there is at least one error in the set of annotations, then the reviewer can reject the set of annotations (potentially with notes as to the reason for the rejection), and the set of annotations can be sent back to the annotation queue 202 to be reviewed again by an available reviewer, which may be the same as, or different from, the reviewer(s) who previously generated or updated the annotations. As mentioned, there may be multiple iterations of this process, with multiple instances of annotation adjustment and review, that may involve the same people or potentially multiple different people for different iterations. The process can continue until a set of annotations is approved for ground truth, or until another end criterion is satisfied. For example, there may be a maximum number of iterations allowed before it is determined that an instance of sensor data should be excluded from consideration as ground truth, such as where there is an artifact in an image that prevents the image from being accurately annotated. A reviewer (or potentially annotator) can also reject some instances of sensor (or other input) data to be annotated, such as where an instance is of insufficient quality to provide accurate annotations, among other such reasons. If an annotator rejects an instance, that instance might be sent to a reviewer to confirm in some embodiments, since such data can be expensive and time-consuming to obtain or generate in at least some embodiments.

Such an approach can help to reduce the review (e.g., quality assurance) cost by allowing some instances of training data to be automatically approved without review if the probability of those instances including an error is low. Such an approach can also help to increase accuracy by ensuring that reviewers spend their efforts on instances that have a higher probability of having at least one error. As mentioned, having a reviewer be more focused by avoiding the review of long sequences of instances with nothing to adjust can improve accuracy while also decreasing both annotator (which can be more expensive than a reviewer) and computing resource cost, as well as average review latency. In one example testing scenario, such an approach was observed to allow for approximately 50% of the sets of annotations to be approved without need for human review, while allowing for approximately 90% of the identified high-risk jobs to be reviewed by a human reviewer. It should be noted that even though a set of annotations might be considered high-risk, there may in fact be no errors in the annotations, so such a process can drastically improve the processing speed and reduce the cost of the QA process, while seeing only a small reduction (say less than 5% or less than 3%) in accuracy. It should be noted that even when a human reviews a set of annotations that there is still some probability of error, so the difference is even less significant. In some embodiments, a subset of the annotations approved by a reviewer might also be passed through an ML model to determine whether the annotations are of sufficiently high probability of error that another reviewer should review before approval, and in the case of an identified potential error might cause the annotations to go back to the reviewer and/or annotator for at least one other iteration of review.

In at least one embodiment, the machine learning model 210 can be a linear regression model, although other models such as convolutional neural networks (CNNs) can be used as well within the scope of the various embodiments. Other approaches may utilize a decision tree model, support vector machine, and the like. The model can be trained using a consensus approach, allowing for an accuracy score to be inferred for each individual label in a set of labels or annotations. In at least one embodiment, the scores can be cross-validated against previous QA decisions or other such data. Parameters of a loss function or training algorithm can be used to determine how much to weight each factor, discussed in more detail elsewhere herein, when generating an accuracy score or other such metric. The model can be trained on data that represents human behavior and response, to function as a human annotator or reviewer might.

The machine learning model 210 can analyze a set of annotations for an instance of input data (e.g., sensor data), and can generate a probability that the set of annotations contains at least one error. The probability can be provided in various forms, such as a risk score, likelihood, probability, and the like. This score or probability can be compared against, for example, a risk threshold to determine whether the risk is “high” or “low,” or above or below the threshold, and thus should be approved as accurate annotations or sent to a reviewer for review. There may be other possible options as well, as may be based on additional thresholds or ranges in other embodiments. For example, there may be a middle risk range where annotations can be reviewed if there are available resources or reviewers, or where at least a fraction of the annotations are sent for review, etc.

In at least one embodiment, the machine learning model 210 is trained using training data that corresponds to the annotations themselves, without the underlying or associated input data. Thus, an instance of training data might correspond to what is illustrated in the view 150 of FIG. 1B, which includes only the geometric representations, labels, and other such aspects of the various annotations. The model is trained using data for sets of annotations that have been evaluated using an evaluation approach, such as a “consensus” evaluation approach, and based on previous reviewer (e.g., QA) scores. A model can be trained to consider any of a number of features of a set of annotations, such as may include the nature of the labeling task itself, as certain types of annotation tasks are more likely to contain errors than others. As an example of the nature or type of labeling task, a labeling task might involve identifying either a dog or a cat facing the camera and centered in an image, which will likely have a much lower risk of error than a type of labeling task to label objects represented in a view of a congested city intersection that may have dozens of cars, and even more scooters and pedestrians. Another example of the nature of a labeling task may relate to whether this is an initial labeling, a review of an autolabeling process, or a review of a label applied by a human user, among other such options. The model can consider the proportion of objects labeled with each object classification, such as how many objects are labeled as a car, bus, or person, as each type of object can have a different probability of being mislabeled, and that may increase (or decrease) if there are many instances of objects of that type to be annotated.

In at least some embodiments, the model may also consider the distance from the camera or sensor at which an object was likely captured, if available or determinable. As an example, an object that is closer to the camera in an image will appear bigger and be easier to accurately annotate than an object that is far away from the camera and appears much smaller, such as may be represented by only a few pixels in some embodiments. In at least one embodiment there might be a maximum distance at which objects are considered able to be reliably annotated (e.g., high-risk), or a minimum size (e.g., dimension or number of points or pixels) in an instance of input data for which an object is considered able to be reliably annotated (e.g., low-risk). In some embodiments, a model might simplify the problem by considering the proportion of objects that fall within ranges of distance from a camera or sensor, or distance “bins.” If the majority of the objects are in a “close” bin, such as within 20 feet of the camera, then there may be a relatively low probability of error, while if the majority of the objects are in the bin that is at the greatest distance, (e.g., 300 feet to 400 feet), then there may be a higher probability of error due in part to limited resolution of the data for objects at that distance. Such considerations are based on the annotations themselves.

There may be additional considerations used to train the model that are related to the annotations and may have an impact on the probability of accuracy. For example, some of the annotations may have been predicted by an autolabeling algorithm, where the human reviewer may or may not have made a modification, while other annotations will have been generated by a human reviewer. There can be a different probability of error associated with each source of annotation. Further, various autolabeling algorithms can provide confidence values along with the labels or annotations, and the model can determine the overall risk based in part upon these confidence values, such as the proportion that fall into each of a number of confidence bins. If most autolabels fall within a high confidence bin then there may be a much lower probability of an error than if most autolabels fall within a low confidence bin, or below a low confidence threshold, etc. The model can also consider the proportion of the objects that have had autolabels applied, as well as the proportion of autolabels that do not have final human labels (or that were at least manually verified or adjusted by a human labeler or annotator).

In some embodiments, the model might consider historical data as well, if available. This might include, for example, the historic performance of the individual human annotator. As an example, a newly hired and inexperienced annotator may have a higher rate of error than an experienced annotator who has been doing the job for a long period of time. The model might also consider the date and time when the annotation was performed, as the probability of an error on Monday morning may be different than the probability of error on Friday afternoon, or during a late night or weekend shift. The model might also consider the historical performance for a type of annotation task and/or a location of the annotation task. For example, the probability of error at a congested intersection in a city might be much higher than the probability of error at an intersection with little traffic in that same city. The model might also consider historical performance based on the season or time of day when the data was captured, as data captured at night or in the winter may have a different probability of an error than data captured on a sunny day in the summer, etc. The probability might also depend upon the type of data being analyzed, as image data will likely present a different probability of error than LIDAR or point cloud data.

The machine learning model can thus be trained using any or all of this training data, until the model converges or another appropriate end condition is met, such as by using a determined number of training iterations or using all (or a determined amount) of the available training data one or more times. The model can also be trained using additional training data over time for continued learning. The model can be trained to take in a set of annotations, without the underlying input data that was annotated, and generate a probability of risk, risk score, or risk classification with confidence value, among other such options. If some of the information discussed above for consideration is not included in, or with, the set of annotations, then that information may be provided as additional input as well. In at least one embodiment, a set of annotations can take the form of a file, object, or repository, for example, which can include at least some of the relevant information in addition to the annotations, as may correspond to the identity of the reviewer, a historical performance metric for the reviewer, which annotations were generated by an autolabeler, information about the time and location of the data capture, and the like. If the model is trained to make determinations only on aspects of the annotations such as the types, distance bins, and type proportions, then at least some if not all of this additional information may not be needed.

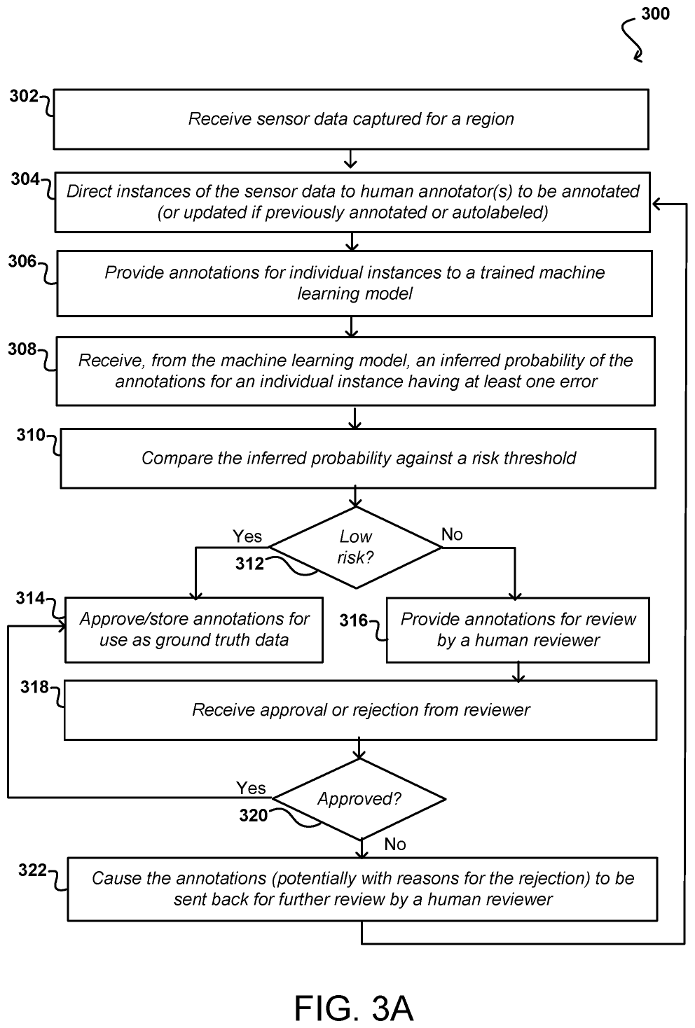

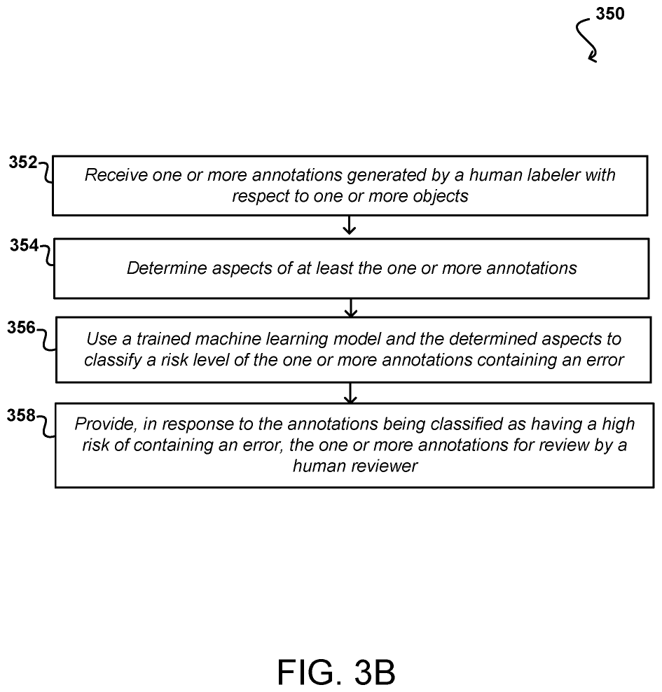

FIG. 3A illustrates a first example process 300 that can be performed to generate, review, modify, and/or approve annotation for a set of input data, in accordance with various embodiments. It should be understood that for these and other processes presented herein there may be additional, fewer, or alternative steps performed in similar or alternative orders, or at least partially in parallel, within the scope of the various embodiments unless otherwise specifically stated. Further, although this example will be discussed with respect to sensor data captured for objects in a physical environment, there can be other types of data that are to be labeled and/or reviewed by at least one human that can benefit from aspects of such a process as well within the scope of various embodiments. In this example process 300, sensor data is received 302 that was captured for a region. This may include, for example, image, depth, LIDAR, or other such data captured using one or more sensors operating in, or proximate, that region. There may be many instances of such data, as may be captured at different times using the same, or different, sensors, such as may be on multiple vehicles navigating through the region.

In this example, each instance (or at least a subset of instances) of the sensor data is directed 304 to one or more human annotators to be annotated. The instances can be stored to an annotation queue, for example, and directed to an annotator according to a queue order as the annotators have availability. The data may have been processed using an autolabeler or other such automated process to attempt to generate an initial set of annotations, to hopefully save the human reviewer time, or may have had annotations applied during a previous review iteration that were determined to include at least one potential error, among other such options. An instance of sensor data may include an image, point cloud, or other representation of one or more objects captured at a single location at a single point in time in at least one embodiment. The “sensor data” may also have been pre-processed and may include a representation of the region that was generated from the raw sensor data and now represents “processed” sensor data, or other such input. The human reviewer can review the sensor data and generate (or update, as appropriate) a set of annotations, as may include geometric representations of objects (e.g., cuboids), object labels, and the like. These generated annotations for individual instances of input data can be provided 306 to a trained machine learning model to perform inferencing. The machine learning model can analyze various aspects of the annotations, such as the types of annotations, proportions of annotations of specific types, and proportions of annotations associated with different distance bins, among other such options. Based in part on these aspects, and other relevant input information as discussed and suggested elsewhere herein, the machine learning model can infer a probability that the annotations include at least one error. This can come in the form of a risk score, a probability score, or a risk classification with confidence level, among other such options. An inferred probability, or other such inference, can be received 308 from the machine learning model, indicating a probability that the annotations for a given data instance contains at least one error. This inferred probability can be compared 310 against a risk threshold (or other such criterion, metric, or range) to determine whether the annotations should be at “low-risk” or “high-risk” of containing at least one error. In this example, “high-risk” annotations have a probability of containing at least one error that is at or above a risk threshold, while “low-risk” annotations have a probability of containing at least one error that is at or below such a risk threshold, although other numbers and types of such risk-type classifications can be used as well within the scope of the various embodiments.

If it is determined 312, in this example, that a set of annotations is low-risk, then those annotations can be approved 314 and stored to a repository for use as ground truth data (or another such purpose), without a need for human review. If, however, it is determined 312 that a set of annotations is not low-risk, then those annotations can be provided 316 for review by a human reviewer. In at least one embodiment, at least some amount of low-risk annotations may also be provided for review by a human reviewer, in order to ensure that the risk threshold is set correctly and that annotations are accurately being determined to be low-risk, among other such advantages. A human reviewer can review the annotations with respect to the instance of input data, and as a result an approval or rejection of the annotations can be received 318. If the annotations were approved, then the annotations can be approved 320 in the system and stored for use as ground truth data (or for another such purpose). If the annotations are not approved by the human reviewer, then the annotations can be caused 322 to be sent back for further review and/or adjustment by a human reviewer. In some instances, the reviewer may provide instructions or recommendations as to the perceived error(s). This process can continue until the annotations are finally approved by the machine learning model or a human reviewer, or an end criterion is satisfied, such as where a set of annotations has been rejected a maximum number of times or a human indicates that the respective training data is insufficient to allow for accurate annotation, among other such options.

FIG. 3B illustrates another example process 350 that can be performed to perform annotation review and approval in accordance with at least one embodiment. In this example, one or more annotations can be received 352 that were generated (or at least updated or approved) by a human labeler with respect to one or more objects. One or more aspects of at least the annotations can be determined 354, as may relate to the type of annotation, proportions of specific types of annotations, and distances to the objects associated with each annotations, among other such options. Aspects relating to the objects, the human labeler, or the time or location at which data was captured that was used for the annotations can be used as well in at least one embodiment. In this example, a trained machine learning model can be used 356, along with the determined aspects, to classify or infer a risk level that the one or more annotations include at least one error. In this example, if the one or more annotations are classified or inferred as having a high-risk of containing at least one error, or at least a probability of risk that is above a risk threshold, then the one or more annotations can be provided 358 for review by a human reviewer, in order to have a second pair of eyes verify the risky annotations. In at least one embodiment, at least some low-risk annotations may be provided for human review as well, for purposes such as those discussed elsewhere herein.

As mentioned, such an approach has various advantages, including enabling a human reviewer to focus on higher risk annotations than a large volume of low-risk annotations that are probably mostly correct and require no action to be taken by the human reviewer. In order to further improve performance of a human reviewer, who may lose focus or demonstrate reduced effort over a period of time with few actions to be taken, such a system can intentionally introduce errors into the annotations to be reviewed. Periodically introducing errors can have multiple advantages. First, the need to catch and identify these errors on the part of a human reviewer can help to keep that reviewer focused and engaged. Further, if these intentional errors are missed, then it may be a sign that one or more remedial actions may need to be taken, such as to recommend that the reviewer take a break, or assign that reviewer to another task for a period of time, among other such actions.

In at least one embodiment, sets of annotations can be selected at random for error introduction. In some embodiments, there may be certain criteria used to determine when to introduce an error. Such a criterion might include, for example, the human reviewer having reviewed for a minimum period of time or minimum number of annotations, overall or without catching an error or having to perform an action. Such a criterion also might be reviewer-dependent, as different users can lose focus after different lengths of time. Such a criterion might depend in part upon the repetitive nature of the task or types of annotations. Another criterion might be the determination that the reviewer is flagging annotations for correction that do not require correction, among other such options. Errors can be introduced as frequently as needed, although consideration should be paid to not introducing an unacceptable amount of latency or processing in the overall annotation review process.

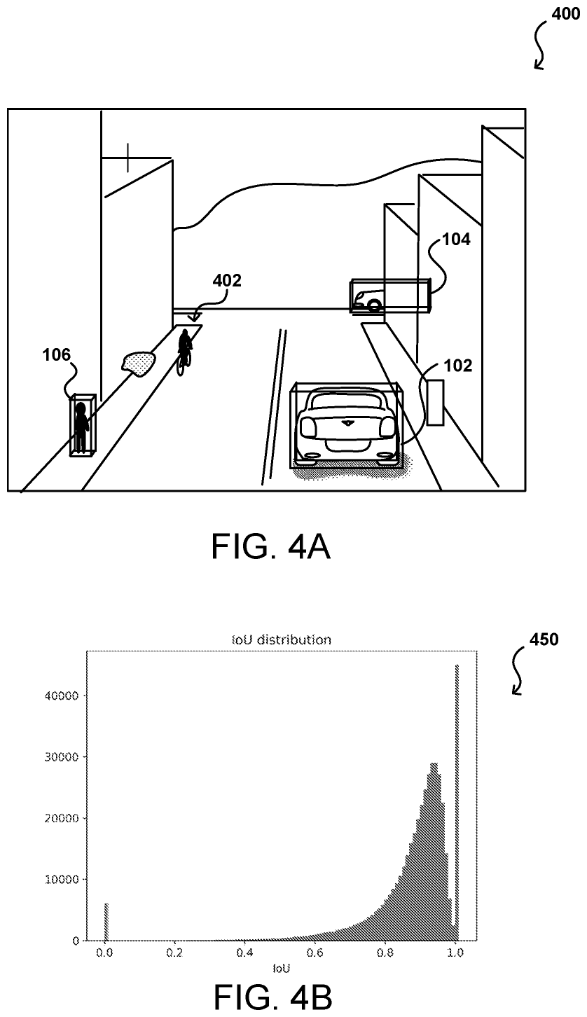

When intentionally introducing an error, a set of annotations can be obtained that has low likelihood of already including an error. This can ensure that the reviewer focuses on the intentional error. The intentional error can include deleting a correct annotation, or adding an incorrect annotation. For example, in the image 400 of FIG. 4A it can be seen that the annotation of the cyclist 402, which was present in FIG. 1A, has been removed. If this version were submitted to a human reviewer, the reviewer should catch the error and reject the annotations as including an error. The reviewer might also indicate that an annotation of a cyclist appears to have been missed, and may also indicate the general location of the object corresponding to the missed annotation. In other embodiments, an annotation might be modified to include incorrect information, such as to indicate the incorrect type of object, or to incorrectly identify the location of the object, such as by incorrectly moving or resizing the geometric representation of an object as part of an annotation. Various other errors can be introduced as well within the scope of the various embodiments, and the system can ensure to present the reviewer with different types of errors over time. Artificially removing annotations or injecting false annotations into a scene can intentionally raise the error rate, which can help to keep a human QA reviewer engaged. When removing labels, a high confidence label can be selected at random, such as by using the features of the above-described model, and the label hidden. Feedback may be provided to the reviewer based on their discovery, or lack of discovery, of the artificial error. The injection of a label can be achieved by copying an existing annotation, for example, and translating the copy to another location, being careful not to overlap with an existing annotation. This can cause the annotation to be at least somewhat realistic for the scene, and make it a little more challenging for the reviewer to detect the error, which can help to improve engagement.

FIG. 4B illustrates an example accuracy plot 450 for a group of annotations for a given scene. This can be a measure of accuracy score, or IoU (intersection over union of provided versus ideal label). As illustrated, if 0.0 is totally inaccurate and 1.0 is totally accurate, the vast majority of the annotations are highly accurate. As illustrated, there are very few sets of annotations that are less than 50% accurate, with the vast majority being at least 80% accurate. A risk threshold can be set by considering such a distribution 450. A risk threshold set at 90% would result in nearly half of the annotations not needing to be reviewed, as was observed as discussed previously. The risk threshold can be lowered, which can cause fewer annotations to have to be reviewed, but will also reduce the overall accuracies of the annotations, which may be important depending on the intended use of the annotations. If cost is a driving factor and high accuracy is not needed, it can be seen that for this set of annotations a risk threshold of 80% would still result in reasonably accurate results, with a small fraction of the annotations needing to be reviewed. If the reviewers can then also be led to be more consistently engaged, the accuracy will further improve, which may allow for use of a lower risk threshold and require less review.

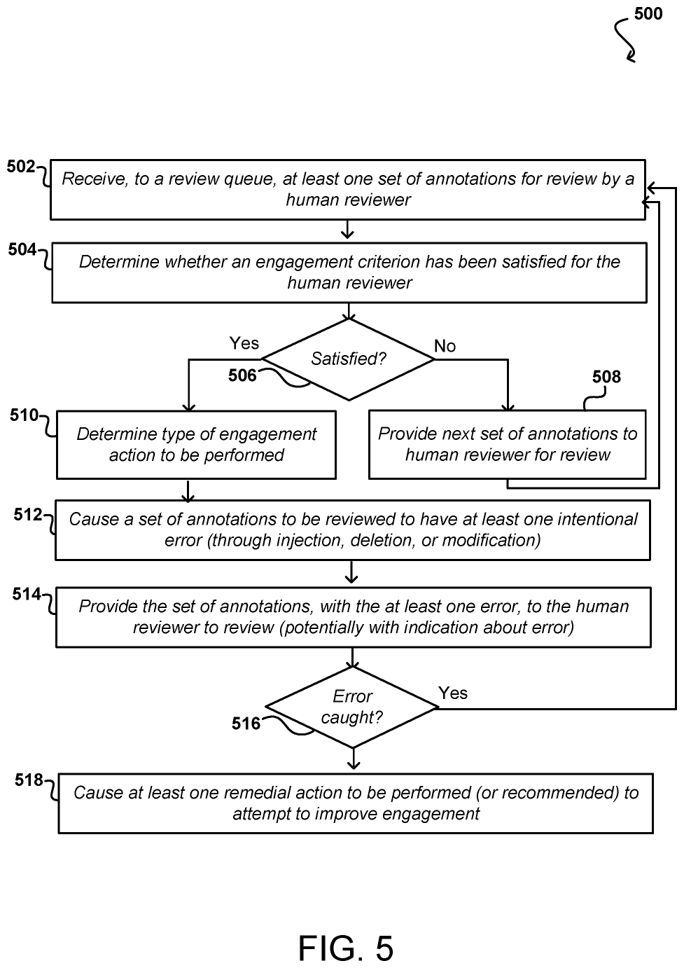

FIG. 5 illustrates an example process 500 that can be performed to maintain a level of engagement for a human reviewer, according to at least one embodiment. Although discussed with annotations, such a process can be used with any type of data that a human is to review for accuracy or other such purposes. In this example, at least one set of annotations is received 502 to a review queue to be analyzed by a human reviewer. The human reviewer may pull multiple such sets from the queue for review over a given shift, or period of time. The performance of the reviewer can be monitored to attempt to determine 504 whether an engagement criterion has been satisfied for the human reviewer. As discussed elsewhere herein, such a criterion can include factors such as a time of day, length of review without a break, or length of time without detecting an error or otherwise engaging with the annotations, among other such options. If it is determined 506 that such an engagement criterion is not satisfied, then the reviewer can continue with the review by providing 508 the next set of annotations from the queue for the reviewer to review. If, however, it is determined 506 that at least one engagement criterion has been satisfied, then a type of engagement action to be performed can be determined 510. The determination might be based upon factor such as the specific engagement criterion that was satisfied, or recent engagement actions that have been performed for this reviewer, among other such options. A set of annotations to be reviewed can then be caused 512 to have at least one intentional error according to the determined type of engagement action, as may include adding, deleting, shifting, resizing, or otherwise modifying at least one aspect of an annotation. The set of annotations, including the artificial error(s), can be provided 514 to the human reviewer to review. The set of annotations may or may not come with a notification that the set of annotations includes at least one error, depending in part upon the type of engagement action. In at least one embodiment, a first presentation of the annotations with the artificial error might be provided to the reviewer without notification, but if the reviewer does not catch the error, then the annotations might be presented again with indication that there is at least one error in the data, etc.

If it is determined 516 that the error is caught successfully, then the reviewer is properly engaged and the review process can continue. The set of annotations can then be approved with the artificial error removed, as long as the inferred probability of containing an error is otherwise sufficiently low. If it is determined 516 instead that the artificial error is not caught, or is incorrectly identified, then at least one remedial action can be caused 518 to be performed (or recommended to be performed) to improve engagement. These actions can include, as discussed in more detail elsewhere herein, recommending that the reviewer take a break or switching the reviewer to another task or type of review, among other such options.

Aspects of various approaches presented herein can be lightweight enough to execute in various locations, such as on a device such as a client device like a personal computer, workstation, or terminal, in real time. Such processing can be performed on, or for, data or content that is generated on, or received by, that client device or received from an external source, such as streaming data or other content received over at least one network from a cloud server 620 or third party service 660, among other such options. In some instances, at least a portion of the processing, generation, compositing, and/or determination of this content may be performed by one of these other devices, systems, or entities, then provided to the client device (or another such recipient) for presentation or another such use.

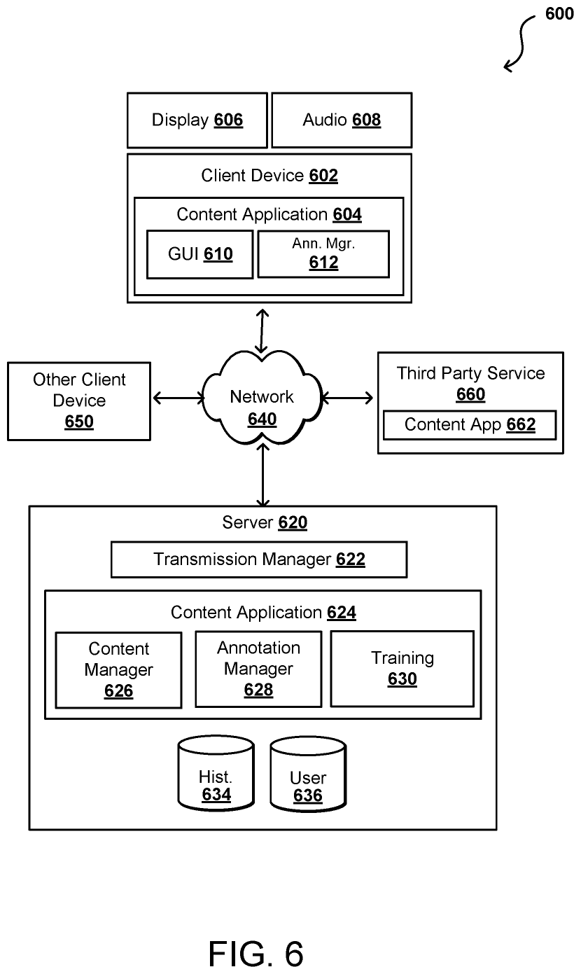

As an example, FIG. 6 illustrates an example network configuration 600 that can be used to provide, generate, modify, encode, process, and/or transmit image data or other such content. In at least one embodiment, a client device 602 can generate or receive data for a session using components of a content application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content, such as one or more instances of sensor data and/or annotations, to be selected by a content manager 626. A content manager 626 may work with an annotation manager 628 to analyze annotations using a machine learning model, for example, to determine whether the annotations should be presented to a human reviewer. Views of the annotations and/or underlying input data can be provided for presentation via the client device 602, which may be used by a reviewer, annotator, or other such user or entity. In at least one embodiment, this annotation 628 can work with a training module 630 that can train (initially or continued) one or more machine learning models to infer a probability of a given set of annotations including at least one error. At least a portion of the content, or decisions regarding the content, may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding content application 604, which may also or alternatively include a graphical user interface 610 and annotation manager 612 for use in viewing, generating, updating, modifying, or otherwise interacting with annotations and/or content to be annotated. At least some of this functionality can be provided for presentation (or other purposes) on or by the client device 602. A decoder may also be used to decode data received over the network(s) 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In some instances, an application executing on a computing device can provide a user interface (UI) that enables a user to provide input to the application for processing, such as may involve a large language model (LLM). For example, a UI can allow a user to provide text or speech entry, for example, which can be used to query or otherwise interact with the application. Such a UI can also be used to add or remove errors, provide feedback, provide additional input, or perform other such operations that can take advantage of an LLM for tasks such as formatting, translation, conversion, auto-completion, and the like.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Inference and Training Logic

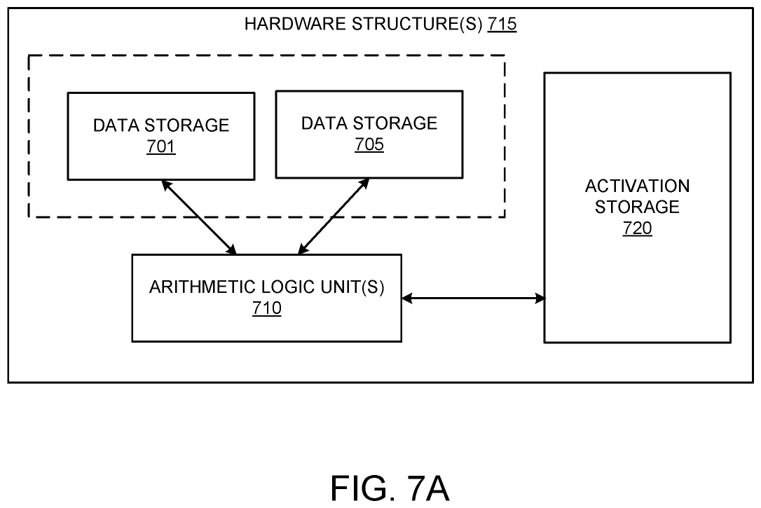

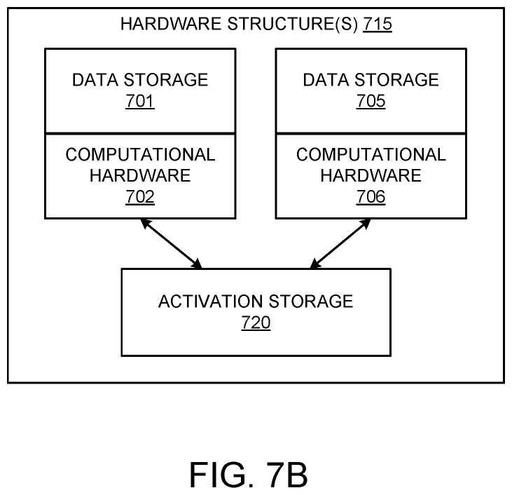

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 701 and/or code and/or data storage 705 are used as operands along with other values, such as bias values, gradient information, momentum values, or other parameters or hyperparameters, any or all of which may be stored in code and/or data storage 701 or code and/or data storage 705 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

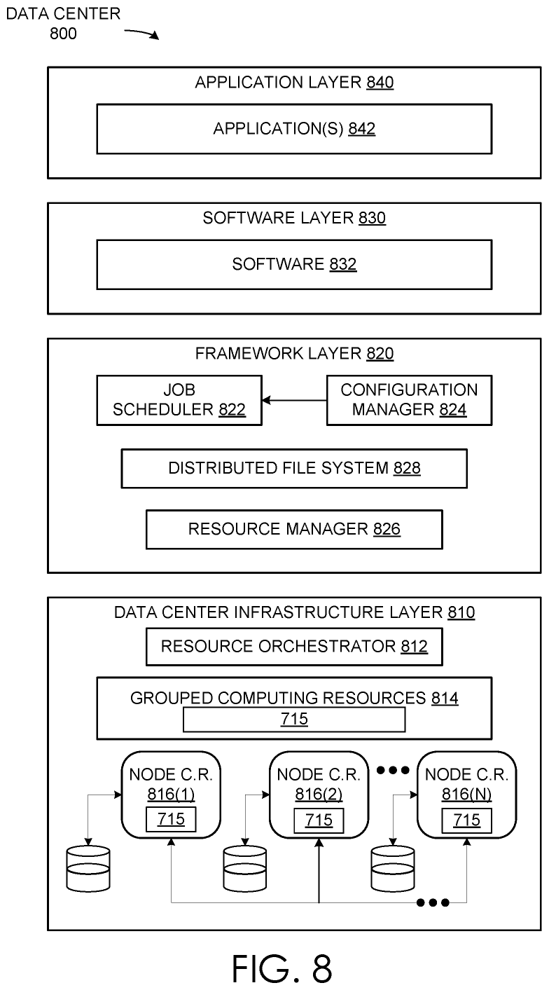

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to generate a tokenized text string representation of an environment that retains spatial and semantic information.

### Computer Systems

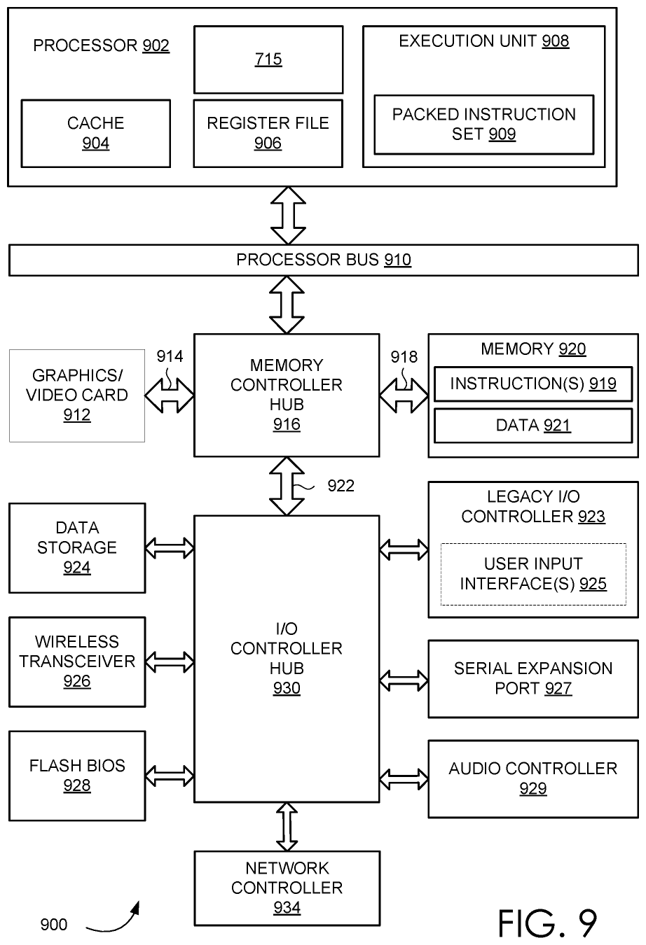

FIG. 9 is a block diagram illustrating an example computer system 900, which may be a system with interconnected devices and components, a system-on-a-chip (SOC) or some combination thereof formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution unit(s) 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word computing (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache 904 may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit(s) 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit(s) 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor data bus 910 for performing operations on packed data, which may eliminate need to transfer smaller units of data across processor data bus 910 to perform one or more operations one data element at a time.

In at least one embodiment, execution unit(s) 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interface(s) 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an example System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to generate a tokenized text string representation of an environment that retains spatial and semantic information.

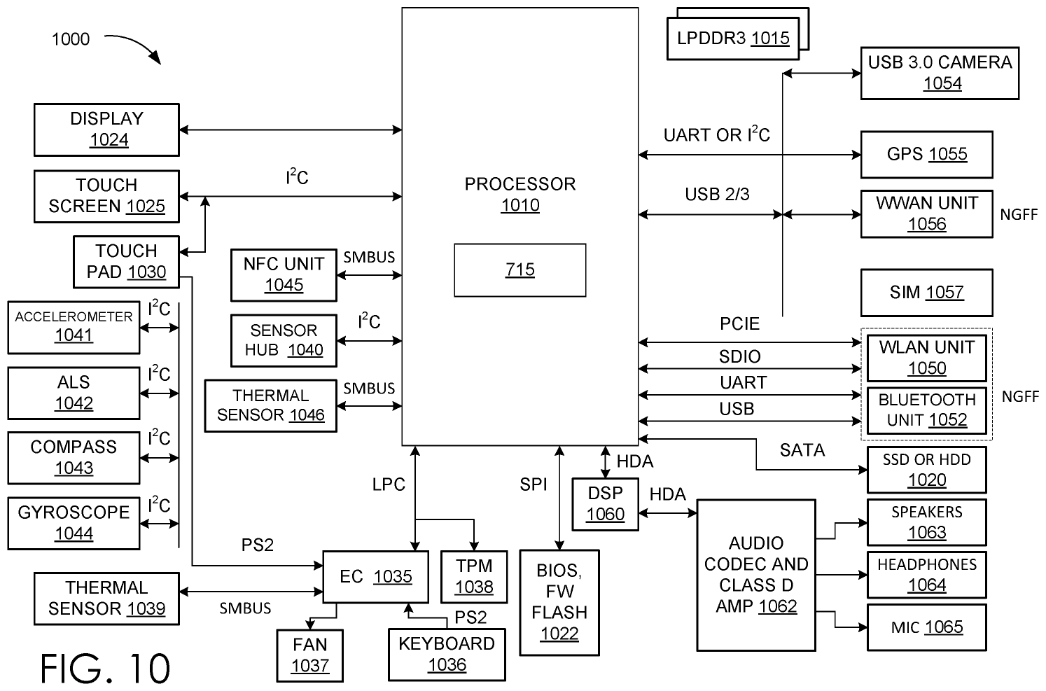

FIG. 10 is a block diagram illustrating an electronic device 1000 for using a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates an electronic device 1000, which includes interconnected hardware devices or “chips”, whereas in other embodiments, FIG. 10 may illustrate an example System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to generate a tokenized text string representation of an environment that retains spatial and semantic information.

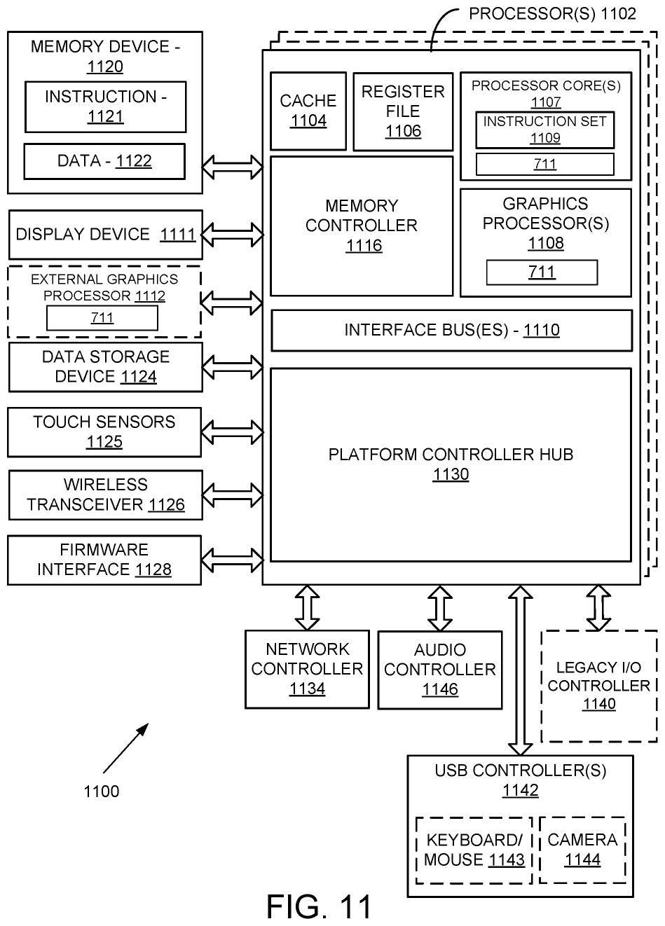

FIG. 11 is a block diagram of a processing system, according to at least one embodiment. In at least one embodiment, processing system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, processing system 1100 is a processing platform incorporated within a system-on-a-chip (SoC) integrated circuit for use in mobile, handheld, or embedded devices.

In at least one embodiment, processing system 1100 can include, or be incorporated within a server-based gaming platform, a game console, including a game and media console, a mobile gaming console, a handheld game console, or an online game console. In at least one embodiment, processing system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory (“cache”) 1104. In at least one embodiment, processor(s) 1102 can have a single internal cache or multiple levels of internal cache. In at least one embodiment, cache 1104 is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in processing system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory buses, or other types of interface buses. In at least one embodiment processor(s) 1102 include an integrated memory controller 1116 and a platform controller hub 1130. In at least one embodiment, memory controller 1116 facilitates communication between a memory device 1120 and other components of processing system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for processing system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 allows peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 allows communication with system firmware, and can be, for example, a unified extensible firmware interface (UEFI). In at least one embodiment, network controller 1134 can allow a network connection to a wired network. In at least one embodiment, a high-performance network controller (not shown) couples with interface bus(es) 1110. In at least one embodiment, audio controller 1146 is a multi-channel high definition audio controller. In at least one embodiment, processing system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, processing system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processing system 1100. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to generate a tokenized text string representation of an environment that retains spatial and semantic information.

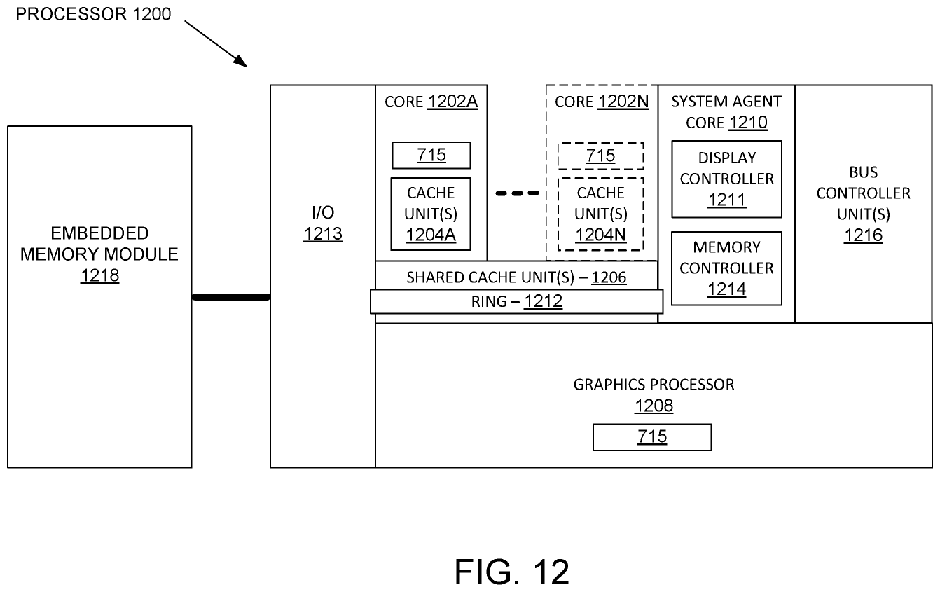

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core(s) 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache memory unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express buses. In at least one embodiment, system agent core 1210 provides management functionality for various processor components. In at least one embodiment, system agent core 1210 includes one or more integrated memory controller(s) 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controller(s) 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory module 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of processor 1200 to perform one or more machine learning algorithms, neural network architectures, use cases, or training techniques described herein.

Such components can be used to generate a tokenized text string representation of an environment that retains spatial and semantic information.

### Virtualized Computing Platform

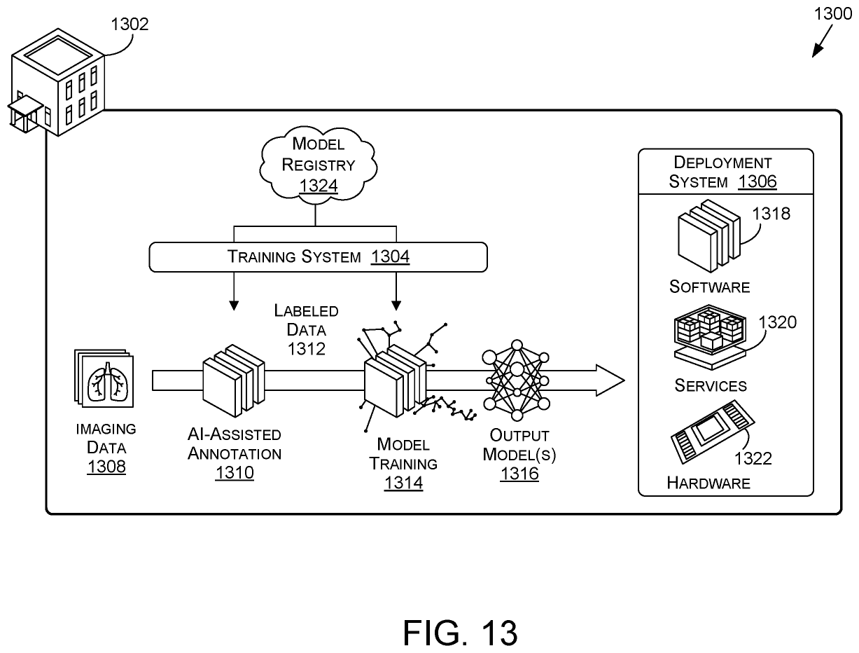

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facility(ies) 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility(ies) 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility(ies) 1302 using data 1308 (such as imaging data) generated at facility(ies) 1302 (and stored on one or more picture archiving and communication system (PACS) servers at facility(ies) 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1304 (FIG. 13) may include a scenario where facility(ies) 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility(ies) 1302 needs a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility(ies) 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility(ies) 1302 requiring a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility(ies) 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility(ies) 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., processor 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by process 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., process 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform). In at least one embodiment, rather than each application that shares a same functionality offered by services 1320 being required to have a respective instance of services 1320, services 1320 may be shared between and among various applications. In at least one embodiment, services 1320 may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility(ies) 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to allow seamless scaling and load balancing.

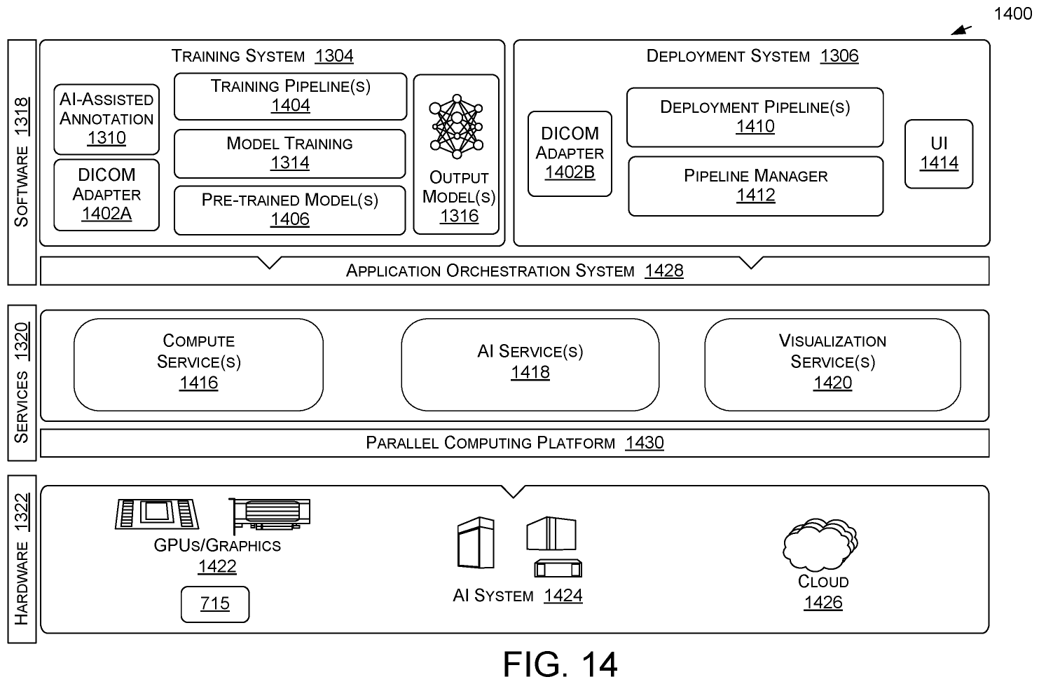

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus (ses), wireless data protocols (Wi-Fi), wired data protocols (e.g., Ethernet), etc.

In at least one embodiment, training system 1304 may execute training pipeline(s) 1404, similar to those described herein with respect to FIG. 13. In at least one embodiment, where one or more machine learning models are to be used in deployment pipeline(s) 1410 by deployment system 1306, training pipeline(s) 1404 may be used to train or retrain one or more (e.g. pre-trained) models, and/or implement one or more of pre-trained model(s) 1406 (e.g., without a need for retraining or updating). In at least one embodiment, as a result of training pipeline(s) 1404, output model(s) 1316 may be generated. In at least one embodiment, training pipeline(s) 1404 may include any number of processing steps, such as but not limited to imaging data (or other input data) conversion or adaption In at least one embodiment, for different machine learning models used by deployment system 1306, different training pipeline(s) 1404 may be used. In at least one embodiment, training pipeline(s) 1404 similar to a first example described with respect to FIG. 13 may be used for a first machine learning model, training pipeline(s) 1404 similar to a second example described with respect to FIG. 13 may be used for a second machine learning model, and training pipeline(s) 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipeline(s) 1404 may include AI-assisted annotation, as described in more detail herein with respect to at least FIG. 14. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation 1310 may be performed as part of deployment pipelines 1410; either in addition to, or in lieu of AI-assisted annotation 1310 included in training pipeline(s) 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility(ies) 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may allow general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to allow seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

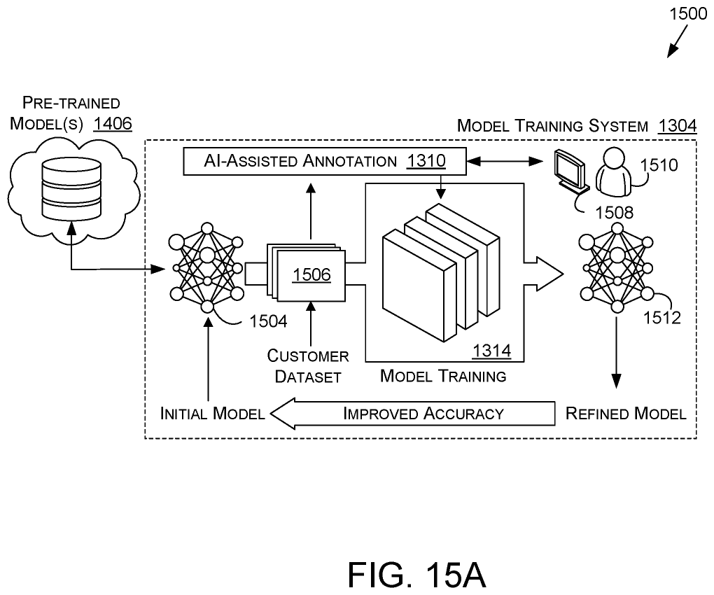

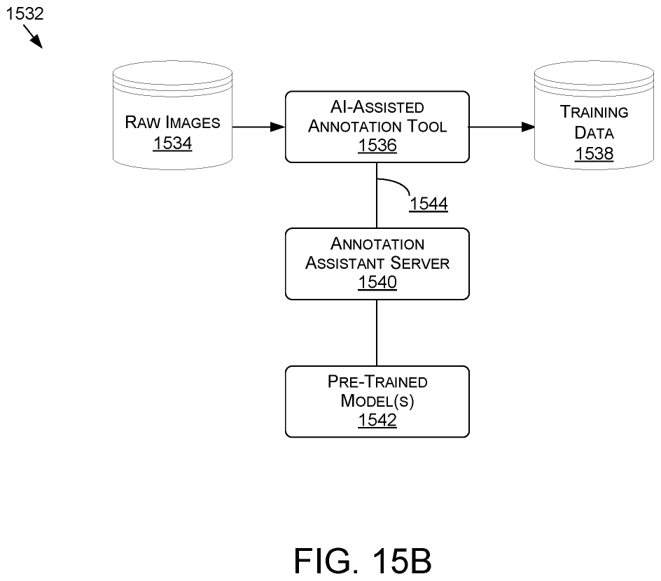

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined model 1512 generated by process 1500 may be executed by a deployment system for one or more containerized applications in deployment pipelines 1510.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training, by having reset or replaced output or loss layer(s) of initial model 1504, parameters may be updated and re-tuned for a new dataset based on loss calculations associated with accuracy of output or loss layer(s) at generating predictions on new, customer dataset 1506.

In at least one embodiment, pre-trained model(s) 1506 may be stored in a data store, or registry. In at least one embodiment, pre-trained model(s) 1506 may have been trained, at least in part, at one or more facilities other than a facility executing process 1500. In at least one embodiment, to protect privacy and rights of patients, subjects, or clients of different facilities, pre-trained model(s) 1506 may have been trained, on-premise, using customer or patient data generated on-premise. In at least one embodiment, pre-trained model(s) 1506 may be trained using a cloud and/or other hardware, but confidential, privacy protected patient data may not be transferred to, used by, or accessible to any components of a cloud (or other off premise hardware). In at least one embodiment, where pre-trained model(s) 1506 is trained at using patient data from more than one facility, pre-trained model(s) 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model(s) 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select pre-trained model(s) 1506 to use with an application. In at least one embodiment, pre-trained model(s) 1506 may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model(s) 1506 may be updated, retrained, and/or fine-tuned for use at a respective facility.

In at least one embodiment, a user may select pre-trained model(s) 1506 that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by model training system 1304. In at least one embodiment, ground truth data may be generated, at least in part, by clinicians, scientists, doctors, practitioners, at a facility.

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto) annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation model(s) 1542, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an annotation assistant server 1540 that may include a set of pre-trained model(s) 1542 stored in an annotation model registry, for example. In at least one embodiment, an annotation model registry may store pre-trained model(s) 1542 (e.g., machine learning models, such as deep learning models) that are pre-trained to perform AI-assisted annotation 1310 on a particular organ or abnormality. These models may be further updated by using training pipelines. In at least one embodiment, pre-installed annotation tools may be improved over time as new labeled data is added.

Various embodiments can be described by the following clauses:

1. A computer-implemented method, comprising:
receiving, with respect to an instance of data including one or more objects, one or more annotations generated using one or more inputs from a human labeler;
determining a set of aspects corresponding to the one or more annotations;
determining, using a machine learning model and based at least on the set of aspects, a probability of the one or more annotations containing an error; and
one of:
   providing, in response to the one or more annotations being determined to have higher than a threshold probability of containing an error, the one or more annotations and the instance of data to a human reviewer; or
   approving, in response to the one or more annotations having less than the threshold probability of containing an error, the one or more annotations without providing the one or more annotations to the human reviewer to review.

2. The computer-implemented method of clause 1, wherein the providing the one or more annotations and the instance of data to the human reviewer includes causing display of the instance of data along with at least one annotation of the one or more annotations within a user interface (UI).

3. The computer-implemented method of clause 1, wherein the one or more annotations are classified as:
high-risk based at least on the probability of the one or more annotations containing an error being higher than the threshold probability; or
low-risk based at least on the probability of the one or more annotations containing an error being less than the threshold probability.

4. The computer-implemented method of clause 3, wherein the threshold probability is adjustable based in part upon a risk tolerance.

5. The computer-implemented method of clause 1, wherein the set of aspects includes at least one of a nature of a task for which the one or more annotations are generated, a proportion of objects labeled with a same object classification, a proportion of objects in each of a plurality of distance bins, or a historic performance of the human labeler.

6. The computer-implemented method of clause 1, wherein the machine learning model includes a linear regression model.

7. The computer-implemented method of clause 1, wherein the one or more annotations are to be used as ground truth data to update one or more parameters of a second machine learning model.

8. The computer-implemented method of clause 1, further comprising:
modifying at least one annotation of the one or more annotations before providing the one or more annotations to the human reviewer, the modifying performed to influence an engagement of the human reviewer.

9. The computer-implemented method of clause 8, wherein the at least one annotation is modified by, at least one of: adding an annotation; deleting an annotation; or shifting a location of the annotation.

10. At least one processor, comprising:
one or more circuits to:
   determine one or more aspects corresponding to a set of annotations generated using a human labeler as part of a labeling task;
   generate, using a machine learning model and based at least on the one or more aspects, a risk score indicating a probability that the set of annotations includes at least one error; and
   one of:
      provide the set of annotations to a human reviewer to review in response to determining that the risk score exceeds a risk threshold; or
      automatically approve the set of annotations in response to the risk score being less than the risk threshold.

11. The at least one processor of clause 10, wherein the set of annotations are provided to the human reviewer via presentation in a user interface (UI).

12. The at least one processor of clause 11, wherein the one or more circuits are further to:
provide, from a plurality of sets of annotations for a region, a limited number of sets of annotations, having a risk score less than the risk threshold, for review by the human reviewer.

13. The at least one processor of clause 10, wherein the set of aspects includes at least one of a nature of a task for which the one or more annotations are generated, a proportion of objects labeled with a same object classification, a proportion of objects in each of a plurality of distance bins, or a historic performance of the human labeler.

14. The at least one processor of clause 10, wherein the one or more circuits are further to:
modify at least one annotation of the one or more annotations before providing the one or more annotations to the human reviewer in order to influence an engagement of the human reviewer.

15. The at least one processor of clause 10, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM),
a collaborative content creation platform for 3D assets; or
a system implemented at least partially using cloud computing resources.

16. A system, comprising:
one or more processors to determine whether to provide one or more annotations, generated using one or more inputs of a human labeler, to be reviewed by a human reviewer based at least on whether a risk score, inferred for the one or more annotations using a machine learning model, meets or exceeds a risk threshold.

17. The system of clause 16, wherein the one or more processors are further to:
infer the risk score based at least on one or more aspects corresponding to the one or more annotations, including at least one of a nature of a task for which the one or more annotations are generated, a proportion of objects labeled with a same object classification, a proportion of objects in each of a plurality of distance bins, or a historic performance of the human labeler.

18. The system of clause 16, wherein the one or more processors are further to:
automatically approve the one or more annotations in response to the risk score being less than the risk threshold.

19. The system of clause 16, wherein the one or more processors are further to:
modify at least one annotation of the one or more annotations before providing the one or more annotations to the human reviewer in order to influence an engagement of the human reviewer.

20. The system of clause 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM),
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
receiving, with respect to an instance of data including one or more objects, one or more annotations generated using one or more inputs from a human labeler;
determining a set of aspects corresponding to the one or more annotations;
determining, using a machine learning model and based at least on the set of aspects, a probability of the one or more annotations containing an error; and
one of:
providing, in response to the one or more annotations being determined to have higher than a threshold probability of containing an error, the one or more annotations and the instance of data to a human reviewer; or
approving, in response to the one or more annotations having less than the threshold probability of containing an error, the one or more annotations without providing the one or more annotations to the human reviewer to review.

2. The computer-implemented method of claim 1, wherein the providing the one or more annotations and the instance of data to the human reviewer includes causing display of the instance of data along with at least one annotation of the one or more annotations within a user interface (UI).

3. The computer-implemented method of claim 1, wherein the one or more annotations are classified as:
high-risk based at least on the probability of the one or more annotations containing an error being higher than the threshold probability; or
low-risk based at least on the probability of the one or more annotations containing an error being less than the threshold probability.

4. The computer-implemented method of claim 3, wherein the threshold probability is adjustable based in part upon a risk tolerance.

5. The computer-implemented method of claim 1, wherein the set of aspects includes at least one of a nature of a task for which the one or more annotations are generated, a proportion of objects labeled with a same object classification, a proportion of objects in each of a plurality of distance bins, or a historic performance of the human labeler.

6. The computer-implemented method of claim 1, wherein the machine learning model includes a linear regression model.

7. The computer-implemented method of claim 1, wherein the one or more annotations are to be used as ground truth data to update one or more parameters of a second machine learning model.

8. The computer-implemented method of claim 1, further comprising:
modifying at least one annotation of the one or more annotations before providing the one or more annotations to the human reviewer, the modifying performed to influence an engagement of the human reviewer.

9. The computer-implemented method of claim 8, wherein the at least one annotation is modified by, at least one of: adding an annotation; deleting an annotation; or shifting a location of the annotation.

10. At least one processor, comprising:
one or more circuits to:
determine one or more aspects corresponding to a set of annotations generated using a human labeler as part of a labeling task;
generate, using a machine learning model and based at least on the one or more aspects, a risk score indicating a probability that the set of annotations includes at least one error; and
one of:
provide the set of annotations to a human reviewer to review in response to determining that the risk score exceeds a risk threshold; or
automatically approve the set of annotations in response to the risk score being less than the risk threshold.

11. The at least one processor of claim 10, wherein the set of annotations are provided to the human reviewer via presentation in a user interface (UI).

12. The at least one processor of claim 11, wherein the one or more circuits are further to:
provide, from a plurality of sets of annotations for a region, a limited number of sets of annotations, having a risk score less than the risk threshold, for review by the human reviewer.

13. The at least one processor of claim 10, wherein the set of aspects includes at least one of a nature of a task for which the one or more annotations are generated, a proportion of objects labeled with a same object classification, a proportion of objects in each of a plurality of distance bins, or a historic performance of the human labeler.

14. The at least one processor of claim 10, wherein the one or more circuits are further to:
modify at least one annotation of the one or more annotations before providing the one or more annotations to the human reviewer in order to influence an engagement of the human reviewer.

15. The at least one processor of claim 10, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM),
a collaborative content creation platform for 3D assets; or
a system implemented at least partially using cloud computing resources.

16. A system, comprising:
one or more processors to determine whether to provide one or more annotations, generated using one or more inputs of a human labeler, to be reviewed by a human reviewer based at least on whether a risk score, inferred for the one or more annotations using a machine learning model, meets or exceeds a risk threshold.

17. The system of claim 16, wherein the one or more processors are further to:
infer the risk score based at least on one or more aspects corresponding to the one or more annotations, including at least one of a nature of a task for which the one or more annotations are generated, a proportion of objects labeled with a same object classification, a proportion of objects in each of a plurality of distance bins, or a historic performance of the human labeler.

18. The system of claim 16, wherein the one or more processors are further to:
automatically approve the one or more annotations in response to the risk score being less than the risk threshold.

19. The system of claim 16, wherein the one or more processors are further to:
modify at least one annotation of the one or more annotations before providing the one or more annotations to the human reviewer in order to influence an engagement of the human reviewer.

20. The system of claim 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM),
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.
